(19) United States
(12) Patent Application Publication
(10) Pub. No.: US 2007/0106011 A1
(43) Pub. Date: May 10, 2007

(54) Method for producing copolymeric polyacrylate pressure-sensitive adhesive substances, and nitroxide-modified polyacrylates and comb block polymers obtained thereby

(76) Inventors: Marc Husemann, Hamburg (DE); Stephen Zollner, Hamburg (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/529,444

(22) PCT Filed: Feb. 24, 2003
(86) PCT No.: PCT/EP03/01833

§ 371 Date: Dec. 4, 2006

(30) Foreign Application Priority Data
Mar. 22, 2002 (DE) 102 12 831.6

(51) Int. Cl. C08F 8/30

(52) U.S. Cl. 524/555; 524/556

(57) ABSTRACT

Method for producing cohesive and adhesive acrylate pressure-sensitive adhesive substances in which polyacrylates having radical forming functional groups are activated at increased temperatures, and side chains of defined length are formed in a nitroxide-controlled polymerization.

The invention relates to a method for producing copolymeric polyacrylate pressure-sensitive adhesives. Modified polyacrylates are obtained to start with, and can be further processed to comb block polymers. The invention also embraces the use of the resulting comb block polymers for pressure-sensitive adhesive articles.

Polyacrylate pressure-sensitive adhesives are used very frequently in the automobile industry, since they possess numerous advantages over other elastomers. They are highly stable to UV light, oxygen and ozone. Synthetic and natural-rubber adhesives usually contain oxidation-sensitive double bonds, which adversely affect the aging behavior of these adhesives. Another advantage of polyacrylates is their transparency and their capacity for use within a relatively wide temperature range. The high temperature stability is particularly important for automobile applications, since in such applications large temperature differences may occur according to season or region.

Polyacrylate pressure-sensitive adhesives are generally prepared in solution by means of a free radical polymerization. Subsequently they are coated in solution onto the corresponding backing material, using a coating bar, and then are dried. In order to increase the cohesion, the polymer is further crosslinked. It may be cured thermally, by UV or by EBC. This operation is relatively costly and environmentally objectionable, since the solvent is not recycled.

For improvement, the hotmelt process was developed. In that method the pressure-sensitive adhesive (PSA) is applied in the melt to the backing material. Problems, however, have been associated with the introduction of this technology. Prior to the coating operation, the PSA has its solvent removed in a drying extruder. The drying operation is associated with a relatively high temperature and shearing effect, so that particularly high molecular mass and polar polyacrylate PSAs are severely damaged. The copolymerization of styrene produced a marked improvement here. Polystyrene blocks raise the glass transition temperature, which in turn acts to increase the cohesion. Moreover, the polarity of the polystyrene blocks is relatively low, so that the flow viscosity rises only within certain limits. The capacity for hotmelt processing is therefore retained.

The easiest way of incorporating polystyrene into acrylate PSAs is to copolymerize acrylate monomers with styrene. Since in the majority of cases polyacrylates are prepared via a free radical polymerization [Handbook of Pressure Sensitive Adhesive Technology, 1989, D. Satas 2nd Edition, Van Nostrand Reinhold, New York], problems arise here. Styrene has a decelerating effect during the polymerization, and therefore reduces the conversion. Consequently, after the end of the polymerization, a few percent of residual monomers remain, which are unwanted, since they disrupt recycling and lead to irritation in the case of bonds made to the skin. The company Polymer Chemistry Innovations has developed and commercialized methacrylate-terminated polystyrene blocks. Such polystyrene blocks are used even in non-PSA systems as plasticizers [U.S. Pat. Nos. 3,135,717; 3,786,116; 3,832,423; 3,862,267; 4,007,311]. In PSAs too, however, they are used as comonomers [U.S. Pat. No. 5,057,366; U.S. Pat. No. 4,554,324]. This technology is associated with a number of drawbacks. The polystyrene blocks must be prepared, at considerable cost, via a “living” anionic polymerization. This operation requires the complete exclusion of water and oxygen. Moreover, the methacrylation of the polystyrene blocks does not proceed quantitatively. Polystyrene of relatively low molecular weight is introduced into the PSA as a result of this operation, and can act as lubricants. This restricts the shear strength (cohesion). Moreover, the molecular mass, which is fairly high for monomers, lowers the reactivity of the macromonomers. For the polymerization this means that it is fairly difficult to achieve high conversions for high comonomer fractions of methacrylated (acrylated) polystyrene. Problematic in turn are the high residual monomer fraction and the slow reaction time.

Alternatively it is also possible to react polymer blocks (polystyrene blocks) with the acrylate PSA in a polymer-analogous reaction [U.S. Pat. No. 5,057,366; U.S. Pat. No. 4,554,324]. Here again, the central problem is the conversion of the reaction, since two polymers are required to locate themselves at a linkage point and, as a result of the high molecular weight and the high polymer chain length, are relatively slow to react. Moreover, the process is a 2-stage one, since the polystyrene blocks are prepared via anionic polymerization. The problems which arise are the same as mentioned above.

The object of the invention is to avoid the aforementioned problems and in particular to be able to control the cohesion of a PSA without too sharply affecting the flow viscosity.

This object is achieved by the provision, through the method of the invention, of a nitroxide-modified polyacrylate, starting from which, in a guided free-radical polymerization with at least one further monomer, comb block polymers can be obtained, the cohesion and, where appropriate, the adhesion and the tack of the PSA being adjustable as a function of the nitroxide fraction and of the side-chain length.

The method of the invention for producing copolymeric polyacrylate PSAs is preferably characterized by the free-radical polymerization at least of the following constituents:
(A) acrylic acid and/or methacrylic acid and/or derivatives thereof according to the formula
   CH₂═C(R₁)(COOR₂) (I)
where R₁═H or CH₃ and R₂=an alkyl chain having 1-20 carbon atoms,
in a fraction of 45% to 99.95% by weight,
(B) acrylated or methacrylated nitroxide derivatives of the general formula
   CH₂═C(R₁)(COOR₃) (II)
where R₁═H or CH₃ and R₃ is a nitroxide derivative,
in a fraction of 0.05% to 25% by weight.

The monomer mixture for the polymerization preferably further comprises:
(C) vinyl compounds having functional groups, such as hydroxyl groups, sulfonic acid groups, ester groups, anhydride groups, epoxy groups, photoinitiators, amide groups, amino groups, with aromatics, heteroaromatics, heterocycles, ethers, etc., with a fraction of 0-30% by weight.

The monomers for preparing the polyacrylate PSAs are preferably chosen such that the resultant polymers can be used as PSAs at room temperature or higher temperatures, particularly such that the resultant polymers possess pressure-sensitive adhesive adhesion properties in accordance with the “Handbook of Pressure Sensitive Adhesive Technology” by Donatas Satas (van Nostrand, New York 1989).

In a further inventive version the comonomer composition is chosen such that the PSAs can be used as heat-activable PSAs.

In one very preferred manner use is made as monomers A of acrylic or methacrylic monomers which are composed of acrylic and methacrylic esters having alkyl groups of 4 to 14 carbon atoms, and preferably comprise 4 to 9 carbon atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethylhexyl acrylate, 2-ethylhexyl methacrylate, isooctyl acrylate and isooctyl methacrylate, for example.

Further classes of compound for use are monofunctional acrylates and/or methacrylates of bridged cycloalkyl alcohols, composed of at least 6 carbon atoms. The cycloalkyl alcohols may also be substituted. Specific examples are cyclohexyl methacrylates, isobornyl acrylate, isobornyl methacrylates and 3,5-dimethyladamantyl acrylate.

In one preferred embodiment of the invention monomers (C) are itaconic acid, β-acryloyl-oxypropionic acid, trichloroacrylic acid, fumaric acid, crotonic acid, aconitic acid, dimethylacrylic acid or vinylacetic acid, this enumeration not being exhaustive.

In one further preferred embodiment use is made as monomers (C) of vinyl compounds, acrylates and/or methacrylates which carry polar groups such as carboxyl radicals, sulfonic and phosphonic acid, hydroxyl radicals, lactam and lactone, N-substituted amide, N-substituted amine, carbamate, epoxy, thiol, alkoxy and cyano radicals, ethers, halides or the like.

Moderate basic monomers are, for example, N,N-dialkyl-substituted amides, such as N,N-dimethylacrylamide, N,N-dimethylmethylmethacrylamide, N-vinylpyrrolidone, N-vinyl-lactam, dimethylaminoethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide, and N-isopropylacrylamide, this enumeration not being exhaustive.

Further preferred examples as monomers (C) are hydroxyethyl acrylate, hydroxypropyl acrylate, hydroxyethyl methacrylate, hydroxypropyl methacrylate, allyl alcohol, maleic anhydride, itaconic anhydride, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, and tetrahydrofurfuryl acrylate, this enumeration not being exhaustive.

In one further very preferred procedure use is made as monomers (C) of vinyl esters, vinyl ethers, vinyl halides, vinylidene halides and vinyl compounds with aromatic cyclic compounds and heterocycles in a position. Here again, mention may be made, nonexclusively, of certain examples: vinyl acetate, vinylformamide, vinylpyridine, ethyl vinyl ether, vinyl chloride, vinylidene chloride and acrylonitrile.

Moreover, in a further procedure, photoinitiators having a copolymerizable double bond are used as monomers (C). Suitable photoinitiators are Norrish I and II photoinitiators. Examples are, e.g., benzoin acrylate and an acrylated benzophenone from UCB (Ebecryl P 36®). In principle it is possible to copolymerize any photoinitiators which are known to the skilled worker and are able to crosslink the polymer via a free-radical mechanism under UV irradiation. An overview of possible photoinitiators which can be used, and which may be functionalized with a double bond, is given in Fouassier: “Photoinitiation, Photopolymerization and Photocuring: Fundamentals and Applications”, Hanser-Verlag, Munich 1995. To supplement this, use is made of Carroy et al. in “Chemistry and Technology of UV and EB Formulation for Coatings, Inks and Paints”, Oldring (ed.), 1994, SITA, London.

In a further preferred procedure the monomers A described are admixed with copolymerizable compounds (C), which possess a high static glass transition temperature. Suitable components include aromatic vinyl compounds, such as styrene, for example, with the aromatic nuclei being composed preferably of C₄ to C₁₈ building blocks and being able also to include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenyl acrylate and methacrylate, 2-naphthyl acrylate and methacrylate, and mixtures of those monomers, this enumeration not being exhaustive.

The nitroxide derivatives possess preferably the following structures,

Possible nitroxide derivatives 1 and 2 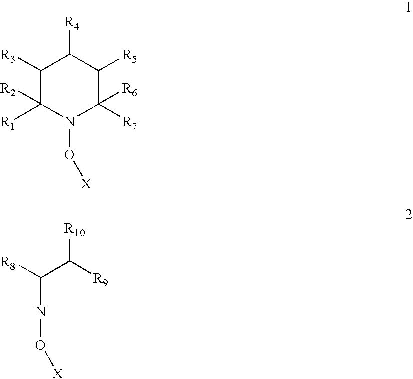
where R₁, R₂, R₆, R₇═CH₃ and R₃, R₄, R₅═H
and R₈=tert-butyl, R₉═H and R₁₀=C1-C10 alkyl (linear, branched, saturated, unsaturated, cyclic, heterocyclic, aromatic, benzylic, ether, silyl ether).

In addition, however, for the purpose of stabilizing radicals, it is also possible for the following nitroxides to be attached via monomer (B) to the poly(meth)acrylate and to initiate a graft polymerization.

In a favorable procedure nitroxides of type (3) or (4) are used: 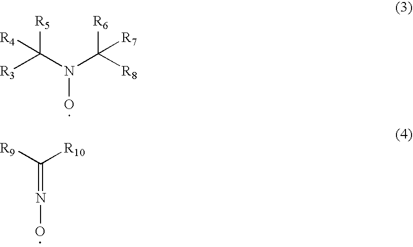
where R³, R⁴, R⁵, R⁶, R⁷, R⁸, R⁹ and R¹⁰ independently of one another denote the following compounds or atoms:
i) halides, such as chlorine, bromine or iodine, for example,
ii) linear, branched, cyclic and heterocyclic hydrocarbons having 1 to 20 carbon atoms, which may be saturated, unsaturated or aromatic,
iii) esters —COOR¹¹, alkoxides-OR¹² and/or phosphonates —PO(OR¹³)₂, where R¹¹, R¹² or R¹³ are radicals from group ii).

Further preferred compounds are:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxy pyrrolidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxy, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide

Alternatively the nitroxide derivative may also be reacted in a polymer-analogous reaction with the polyacrylate (A). The result is a nitroxide-functionalized polyacrylate.

In order to achieve a polymer glass transition temperature, T_{g}, which is preferred for PSAs, i.e., T_{g}≦25° C., the monomers, in accordance with what has been said above, are very preferably selected, and the quantitative composition of the monomer mixture advantageously chosen, in such a way that, in accordance with the Fox equation (E1) (cf. T. G. Fox, Bull. Am. Phys. Soc. 1 (1956) 123), the desired T_{g} value results for the polymer.

$$\frac{1}{{T}_{g}} = {\sum }_{n} \frac{{w}_{n}}{{T}_{g , n}} \qquad ( E 1 )$$

In this formula, n represents the serial number of the monomers used, wₙ the mass fraction of the respective monomer n (% by weight), and T_{g,n} the respective glass transition temperature of the homopolymer of the respective monomer n in K.

To prepare the poly(meth)acrylate PSAs it is advantageous to carry out conventional free-radical polymerizations. For the polymerizations which proceed by a free-radical mechanism it is preferred to use initiator systems which additionally comprise further free-radical initiators for the polymerization, and especially thermally decomposing radical-forming azo or peroxo initiators. In principle, however, all customary initiators that are familiar to the skilled worker for acrylates are suitable. The production of C-centered free radicals is described in Houben Weyl, Methoden der Organischen Chemie, Vol. E 19a, pp. 60-147. Those methods are preferentially employed analogously.

Examples of free-radical sources are peroxides, hydroperoxides and azo compounds. As a number of nonexclusive examples of typical free-radical initiators, mention may be made here of the following: potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate and benzpinacol. In one very preferred version a free-radical initiator used is 1,1′-azobis-(cyclohexanecarbonitrile) (Vazo 88™ from DuPont) or azodiisobutyronitrile (AIBN).

The average molecular weights M_{w} of the PSAs formed in the course of the free-radical polymerization are very preferably selected such that they are situated within a range from 200 000 to 4 000 000 g/mol; specifically for further use as hotmelt PSAs, PSAs having average molecular weights M_{w} of 400 000 to 1 200 000 g/mol are prepared. The average molecular weight is determined by size exclusion chromatography (GPC) or matrix-assisted laser desorption/ionization mass spectrometry (MALDI-MS).

The polymerization may be carried out in bulk, in the presence of one or more organic solvents, in the presence of water, or in mixtures of organic solvents and water. The aim is to minimize the amount of solvent used. Suitable organic solvents are straight alkanes (e.g., hexane, heptane, octane, isooctane), aromatic hydrocarbons (e.g., benzene, toluene, xylene), esters (e.g., ethyl acetate, propyl acetate, butyl acetate or hexyl acetate), halogenated hydrocarbons (e.g., chlorobenzene), alkanols (e.g., methanol, ethanol, ethylene glycol, ethylene glycol monomethyl ether) and ethers (e.g., diethyl ether, dibutyl ether) or mixtures thereof. A water-miscible or hydrophilic cosolvent may be added to the aqueous polymerization reactions, in order to ensure that in the course of monomer conversion the reaction mixture is in the form of a homogeneous phase. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

Depending on conversion and temperature, the polymerization time amounts to between 2 and 72 hours. The higher the reaction temperature can be chosen, in other words the higher the thermal stability of the reaction mixture is, the lower the reaction time that can be chosen.

In order to initiate the polymerization, the introduction of heat is essential for the thermally decomposing initiators. For the thermally decomposing initiators the polymerization can be initiated by heating to 50 to 160° C., depending on initiator type.

For the preparation it may also be of advantage to polymerize the acrylate PSAs in bulk. In this case it is particularly suitable to use the prepolymerization technique. The polymerization is initiated with UV light, but taken only to a low conversion of about 10%-30%. Subsequently this polymer syrup can be welded, for example, into films (in the simplest case, ice cubes) and then polymerized through in water to a high conversion. These pellets can then be used as acrylate hotmelt adhesives, particular preference being given to the use, for the melting operation, of film materials which are compatible with the polyacrylate.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

In this case the living polymer is generally represented by the structure P_{L}(A)-Me, where Me is a metal from group I, such as lithium, sodium or potassium, for example, and P_{L}(A) is a growing polymer of the acrylate monomers. The molar mass of the polymer to be prepared is controlled by the ratio of initiator concentration to monomer concentration. Examples of suitable polymerization initiators include n-propyllithium, n-butyllithium, sec-butyllithium, 2-naphthyllithium, cyclohexyllithium or octyllithium, this enumeration making no claim to completeness. Also known and possible for use here are initiators based on samarium complexes for the polymerization of acrylates (Macromolecules, 1995, 28, 7886).

Moreover it is also possible to use difunctional initiators, such as 1,1,4,4-tetraphenyl-1,4-dilithiobutane or 1,1,4,4-tetraphenyl-1,4-dilithioisobutane, for example. Coinitiators may likewise be employed. Suitable coinitiators include lithium halides, alkali metal alkoxides or alkylaluminum compounds. In one very preferred version the ligands and coinitiators are chosen such that acrylate monomers, such as n-butyl acrylate and 2-ethylhexyl acrylate, for example, can be polymerized directly and do not have to be generated in the polymer by transesterification with the corresponding alcohol.

Also suitable for preparing polyacrylate PSAs with a narrow molecular weight distribution are controlled free-radical polymerization methods. For the polymerization in that case it is preferred to use a control reagent of the general formula: 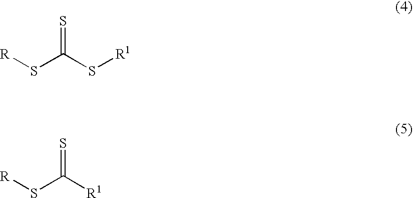
in which R and R¹, chosen independently of one another or identical, are
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one oxygen atom and/or a group NR* in the carbon chain, it being possible for R* to be any desired radical (in particular an organic radical),

C₃-C₁₈ alkynyl radicals, C₃-C₁₈ alkenyl radicals or C₁-C₁₈ alkyl radicals substituted by at least one ester group, amine group, carbonate group, cyano group, iso-cyano group and/or epoxide group and/or by sulfur;
C₃-C₁₂ cycloalkyl radicals;
C₆-C₁₈ aryl or benzyl radicals;
hydrogen.

Control reagents of type (4) are composed preferably of the following further-restricted compounds:

halogen atoms herein are preferably F, Cl, Br or I, more preferably Cl and Br. As alkyl, alkenyl and alkynyl radicals in the various substituents, both linear and branched chains are outstandingly suitable.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl and oleyl.

Examples of alkynyl having 3 to 18 carbon atoms are propynyl, 2-butynyl, 3-butynyl, n-2-octynyl and n-2-octadecynyl.

Examples of hydroxy-substituted alkyl radicals are hydroxypropyl, hydroxybutyl or hydroxyhexyl.

Examples of halogen-substituted alkyl radicals are dichlorobutyl, monobromobutyl or trichlorohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl or trimethylcyclohexyl, for example.

Examples of C₆-C₁₈ aryl radicals include phenyl, naphthyl, benzyl, 4-tert-butylbenzyl or further substituted phenyl, such as ethyl, toluene, xylene, mesitylene, isopropylbenzene, dichlorobenzene or bromotoluene, for example.

The above listings serve only as examples of the respective groups of compounds, and make no claim to completeness.

The obtainable molecular weights M_{w} are between 200 000 and 2 000 000 g/mol, more preferably between 600 000 and 1 000 000 g/mol.

The initial product is a nitroxide-modified polyacrylate, which is a valuable intermediate for the preparation of various comb polymers having broadly adjustable properties.

In continuation of the invention at least one further monomer is added—in a further, subsequent reaction step—to the nitroxide-modified polyacrylate and, after an increase in temperature to at least 100° C., a nitroxide-controlled free-radical polymerization, initiated by the cleavage of the nitroxide derivative and formation of free radicals along the polyacrylate backbone, is carried out to give a comb block polymer.

The method can be guided in a variety of ways. For instance, the nitroxide-modified polyacrylate prepared in solution can be admixed with the further monomer and thereafter can be subjected to a concentration step at elevated temperature, thereby initiating the free-radical polymerization with the further monomer to give the desired comb block polymer during the concentration step.

Alternatively the further monomer may be added to the nitroxide-modified polyacrylate after any concentration that may be necessary. Thereafter this mixture can be further processed directly in a hotmelt process, the free-radical polymerization with the further monomer to give the desired comb block polymer being initiated during the hotmelt process, so that the polymerizational attachment of the side chains takes place during the hotmelt process.

As a further monomer it is preferred to use styrene. Instead of styrene it is also possible to attach other monomers to the polyacrylate backbone by polymerization into the side chains, especially styrene derivatives, acrylates or methacrylates, or mixtures of different monomers.

In one preferred exemplary embodiment of the invention styrene side blocks are attached by polymerization. To initiate the styrene polymerization, in a preferred embodiment, first styrene is metered into the polyacrylate and then the mixture is heated to 130° C. The nitroxide compounds undergo thermal cleavage and produce free radicals along the polyacrylate chain, which effect a controlled polymerization of styrene. The polymer chains grow at the same rate. The lengths of the polystyrene polymer chains are variable. In accordance with the fraction of component B it is possible to adjust the chain length from the molar ratio of the free radicals produced, and the molar amount of styrene added. The molecular weight of the individual polystyrene blocks is preferably between 500 and 50 000, in particular between 4000 and 30 000 g/mol.

The polystyrene side blocks that have formed raise the glass transition temperature, and the cohesion of the PSA increases. Phase-separated systems may also be formed. On the other hand, these PSAs can be processed to very good effect in the hotmelt process, since the glass transition temperature has been raised by means of a relatively apolar component. At the same glass transition temperature, acrylic acid or methyl acrylate would generate a significantly higher flow viscosity for the adhesive. As already described above, the polystyrene-containing PSA can be prepared in two stages. The nitroxide-modified polyacrylate is preferably reacted only in the concentration step with styrene or styrene derivatives. The temperatures employed for this operation are enough to initiate the nitroxide-controlled polymerization. The polystyrene side chains are therefore formed in an extruder or, generally, in the hotmelt process. The method regime that is made possible by the invention is therefore highly advantageous, energy saving, and economic.

Besides styrene, styrene derivatives as well can be produced as polymer side blocks of the polyacrylate main chain by this method. Other monomers too, such as methacrylates and acrylates, can be free-radically polymerized in a controlled, guided way from the main polymer chain. For this purpose the skilled worker ought to select the nitroxide derivatives that are most suitable in each case. This selection may take place experimentally.

Through the side chains it is possible to vary the adhesive properties.

The introduction of styrene and of monomers which as homopolymers possess a higher glass transition temperature than the polyacrylate into the side chains leads to an increase in the molecular weight and in the glass transition temperature. Especially in combination with efficient crosslinking, a higher level of cohesion is attained in the PSA. By contrast, side chains composed of monomers which as homopolymers possess a low glass transition temperature have the effect of raising the adhesion and/or the tack. For example, through the use of 2-ethylhexyl acrylate, it is possible to improve the adhesion and the tack with respect to a variety of substrates.

The length of the side chains can be adjusted by way of the molar ratio of nitroxide to further monomer used for the side chains.

The method of the invention leads to a reduction in the aging as a result of temperature and shearing effects.

The comb block polymer obtained through the invention is especially suitable for producing PSA articles, especially PSA tapes and PSA sheets, which may have been coated on one or both sides with the pressure-sensitive adhesive comb polymer.

To produce the adhesive tapes the polymers described above are blended optionally with crosslinkers: as crosslinkers it is possible, for example, to use polyfunctional acrylates, metal chelates or polyfunctional isocyanates and epoxides.

For further development, the inventive PSAs may be admixed with resins. Tackifying resins for addition which can be used include, without exception, all existing tackifier resins described in the literature. Representatives that may be mentioned include pinene resins, indene resins and rosins, their disproportionated, hydrogenated, polymerized and esterified derivatives and salts, the aliphatic and aromatic hydrocarbon resins, terpene resins and terpene-phenolic resins, and also C5, C9 and other hydrocarbon resins. Any desired combinations of these and further resins may be used in order to adjust the properties of the resultant adhesive in accordance with what is desired. Generally speaking, it is possible to use all resins which are compatible (soluble) with the corresponding polyacrylate; mention may be made in particular of all aliphatic, aromatic and alkylaromatic hydrocarbon resins, hydrocarbon resins based on straight monomers, hydrogenated hydrocarbon resins, functional hydrocarbon resins, and natural resins. Explicit reference may be made to the depiction of the state of knowledge in the “Handbook of Pressure Sensitive Adhesive Technology” by Donatas Satas (van Nostrand, 1989).

Additionally it is possible, optionally, for plasticizers, further fillers (such as fibers, carbon black, zinc oxide, chalk, solid or hollow glass beads, microbeads of other materials, silica, silicates, for example), nucleators, blowing agents, compounding agents and/or aging inhibitors, in the form of primary and secondary antioxidants or in the form of light stabilizers, for example, to be added.

In addition it is possible to admix crosslinkers and crosslinking promoters. Examples of suitable crosslinkers for electron beam crosslinking include difunctional or polyfunctional acrylates. Suitable crosslinkers are known in the state of the art. Crosslinkers which can be used are, for example, SR 610 (Sartomer), PETIA, PETA, Ebecryl 11 (UCB) and other polyfunctional acrylates and/or methacrylates, such as SR 350 from Sartomer, for example.

The acrylate PSAs blended in this way are applied from solution or as a hotmelt to a backing (BOPP, PET, nonwoven, PVC, foam, etc.) or release paper (glassine, HDPE, LDPE) and are subsequently crosslinked in order to raise the cohesion, as is fundamentally known very well in the state of the art. Where a crosslinker has been added, the adhesives are crosslinked thermally, with UV light or with ionizing radiation, as is likewise known and described in the literature.

Typical EB irradiation devices that may be employed are linear cathode systems, scanner systems and segmented cathode systems, where electron beam accelerators are concerned. An extensive description of the state of the art and the major method parameters are found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably 80 kV and 300 kV. The radiation doses employed range between 5 to 150 kGy, in particular between 20 and 100 kGy.

In the text below the invention is described in more detail with reference to examples which are intended to illustrate the invention but should not be understood as being restricting.

Example Section

Fundamental Considerations

A central point for the preparation of sideblock-modified acrylate PSAs is the synthesis of suitable acrylated or methacrylated nitroxides. For the polymerization of styrene compounds [Hawker, C. J.; Barclay, G. G.; Dao, J.; Journal American Chemical Society 1996, 118, 11467; Hawker, C. J.; Barclay, G. G.; Orellana, A.; Dao, J.; Devonport, W.; Macromolecules, 1996, 29, 5245] a variety of derivatives of TEMPO (TEMPO=2,2,6,6-tetramethylpiperidineoxy) have already been used. Through rational further development these initiators have been further modified, so that nowadays even acrylate compounds and methacrylate compounds can be polymerized in a controlled fashion using nitroxide compounds [Hawker, C. J., paper, National Meeting of the American Chemical Society, San Francisco, spring 1997; German patent DE 19909767 A1].

For the invention it is possible to use, among others, the following acrylated nitroxide derivatives (component (B)): 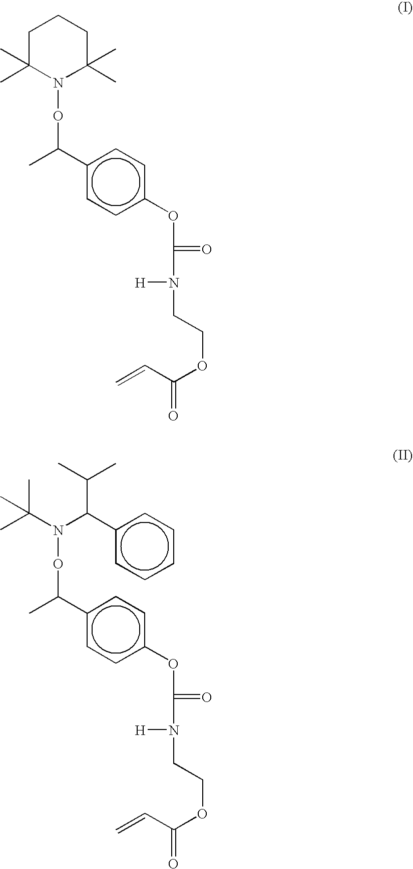
1-(4′-acryloylethylcarbamoylphenyl)-1-(2″,2″,6″,6″-tetramethyl-1-piperidinyloxy)ethyl (I) and 2,2,5-trimethyl-3-(4-acryloylethylcarbamoyl-1-phenylethoxy)-4-phenyl-3-azahexane (II)

Alkoxypiperidine (I) is a TEMPO derivative and is very suitable for the polymerization of styrene. In contrast, the nitroxide (II) is a highly efficient initiator for the polymerization of acrylates and methacrylates. (I) and (II) carry out controlled free-radical polymerizations, so that the polymers formed have a low dispersity of 1-2.0, according to reaction regime and molecular weight of the polymer.

The preparation of the alkoxypiperidine compound for the examples took place by the coupling of TEMPO to acetoxystyrene by means of a Jacobsen catalyst (Journal Polymer Science, Part A: Polymer Chemistry 1998, 36, 2161) with subsequent hydrolysis of the acetoxy function using ammonium hydroxide (Macromolecules, 1998, 31, 1024-1031). The acrylation of the hydroxyl function took place with 2-isocyanatoethyl acrylate with formation of carbamate (Satchell and Satchell, Chemical Society Reviews 1975, 4, 231-250). A similar procedure was adopted for the acrylated nitroxide (II). The starting compound was prepared by the method of Hawker (Journal American Chemical Society 1999, 121, 16, 3904-3920).

To prepare the acrylate PSAs the following acrylates were first of all polymerized with the comonomer concentrations compiled in table 1. The TEMPO functions and nitroxide functions were obtained by conventional polymerization at 60° C. using AIBN (azoisobutyronitrile). butyronitrile).

TABLE 1

| Example | AA [%] | 2-EHA [%] | MA [%] | A [%] | B [%] |
|---|---|---|---|---|---|
| 1 | 8 | 86.5 | 5 | 0.5 | 0 |
| 2 | 4 | 90.25 | 5 | 0.75 | 0 |
| 3 | 6.5 | 83.5 | 8 | 2 | 0 |
| 4 | 6 | 87.85 | 6 | 0.15 | 0 |
| 5 | 6 | 88 | 4 | 0 | 2 |
| 6 | 7 | 82 | 10 | 0 | 1 |

In order to work out the effect of the polystyrene side chains, the examples were first of all applied from solution to a primed polyester film at 50 g/m² and dried at 50° C. The specimens were subsequently cured by EBC and subjected to adhesion testing. Assessment was carried out using the shear test at room temperature (cohesion) and the bond strength to steel. The results are shown in table 2:

TABLE 2

| | | BS-steel | SWT RT |
|---|---|---|---|
| Example | EBC [kGy] | instantaneous [N/cm] | 10 N [min] |
| 1 | 30 | 4.5 | 4350 |
| 2 | 30 | 4.7 | 1265 |
| 3 | 25 | 4.2 | 2365 |
| 4 | 30 | 4.5 | 2680 |
| 5 | 30 | 4.6 | 2575 |
| 6 | 30 | 3.9 | 5655 |

Application rate: 50 g/m²

Adhesion testing showed that examples 1-6 still do not have optimum cohesion. The mark of more than 10 000 minutes required for a cohesive adhesive was not achieved in any case. No great variation was shown by the bond strength to steel. The values fluctuate from about 4 to 4.7 N/cm.

In direct comparison, the side block-modified PSAs were then prepared. Examples 1-4 were reacted with different amounts of styrene in each case. Examples 5 and 6 were reacted with n-butyl acrylate in order to increase the adhesion (bond strength to steel). The amount of comonomer A or B used indicates the molar amounts present in the polymer of the free radicals that have formed along the polymer chain at high temperatures. Through the amount of styrene or n-butyl acrylate metered in it is possible to adjust the molecular weight of the polymer side chain. The side-chain-modified polyacrylates are labeled with a # and additionally summarized in table 3.

TABLE 3

| | PS blocks | PBA blocks |
|---|---|---|
| Example | M_{w} [g/mol] | M_{w} [g/mol] |
| 1# | 20 000 | 0 |
| 2# | 10 000 | 0 |
| 3# | 4000 | 0 |
| 4# | 30 000 | 0 |
| 5# | 0 | 10 000 |
| 6# | 0 | 25 000 |

In analogy to references 1-6, these adhesives were coated out at 50 g/m² onto a primed polyester film and crosslinked with the identical EBC dose. To assess these adhesives, again the shear withstand times at room temperature and the bond strength to steel were employed. The results are listed in table 4:

TABLE 4

| | | BS-steel | SWT RT |
|---|---|---|---|
| Example | EBC [kGy] | instantaneous [N/cm] | 10 N [min] |
| 1# | 30 | 3.8 | +10 000 |
| 2# | 30 | 3.6 | +10 000 |
| 3# | 25 | 3.8 | +10 000 |
| 4# | 30 | 3.9 | +10 000 |
| 5# | 30 | 5.4 | 1250 |
| 6# | 30 | 5.8 | 1470 |

Application rate: 50 g/m²

A comparison of examples 1#-4# with reference examples 1-4 shows that the cohesion of the adhesives increases markedly as a result of the modification with polystyrene blocks. All modified polyacrylates 1#-4# achieved shear withstand times of more than 10 000 minutes at room temperature. As a result of the increased cohesion there was some drop in adhesion. Examples 5# and 6#, in contrast, show better adhesion to steel. As a result of the polybutyl acrylate side chains, the glass transition temperature of the PSA falls, and the compositions exhibit better flow behavior. The bond strength to steel rises by about 1 (example 5)-1.5 N/cm (example 6). In contrast there is a reduction in the shear strength. Nevertheless, the shear strength is not completely lost, since the side chains further increase the overall molecular weight, which in turn promotes the cohesion of the adhesive.

In order to investigate the hotmelt compatibility of this process, a reaction was carried out in a recording extruder at constant temperature. For this experiment use was made again of the polyacrylate adhesive of example 1. Example 1 was converted first at 50° C., by removal of the solvent, into an acrylate hotmelt. 4-Acetoxystyrene was selected for constructing the side chains, the amount of monomer being chosen such that the side chains achieve a molecular weight of 20 000 g/mol in each case. Acrylate hotmelt and 4-acetoxystyrene were mixed and then subjected to thermal treatment and shearing in a recording extruder at 125° C. This operation corresponds to the concentration process with subsequent conveying to the coating die. After 5 h the experiments were ended. The precise experimental parameters are described in the experimental section. The PSA 1* modified with poly-4-acetoxystyrene was coated as a hotmelt through a slot die at 50 g/m² onto a primed polyester film and was subsequently crosslinked with 30 kGy of EBC. To examine the adhesive properties a shearing test was carried out again and the bond strength to steel was measured again (table 5).

TABLE 5

| | | BS-steel | SWT RT |
|---|---|---|---|
| Example | EBC [kGy] | instantaneous [N/cm] | 10 N [min] |
| 1* | 30 | 3.7 | +10 000 |

In analogy to the reactions from solution, with the hotmelt 1* as well a marked increase in cohesion was achieved. In comparison to 1#, however, there are no great changes. The bond strength to steel, at 3.7 N/cm, is at about the same level. A further advantage of the acrylate hotmelts to which nitroxide derivatives have been added is the good aging stability under shearing and thermal load. Free radicals formed as intermediates, which can lead to gelling or to a reduction in molecular weight, are scavenged by nitroxides at high temperatures. The aging process is therefore slowed down significantly.

This invention has been described only in connection with certain examples. Further specific exemplary embodiments are, however, possible. For example, it is certainly possible to use small fractions of other comonomers, such as vinyl acetate or N-vinyl compounds, in an analogous way. The possibilities of variation in principle for the base acrylate material are known to the skilled worker, who is therefore able to incorporate these possibilities into the design of this invention.

The invention will now be described in detail by means of the following experiments:

Experiments

The following test methods were employed in order to evaluate the adhesive properties of the PSAs prepared.

Test Methods

Shear Strength (Test A)

A strip 13 mm wide of the adhesive tape was applied to a smooth steel surface which had been cleaned three times with acetone and once with isopropanol. The area of application was 20*13 mm (length*width). The adhesive tape was then pressed onto the steel backing four times using a 2 kg weight. At room temperature a 1 kg was fastened to the adhesive tape. The shear withstand times measured are reported in minutes and correspond to the average of three measurements.

180° Bond Strength Test (Test B)

A strip 20 mm wide of an acrylate PSA coated onto a polyester was applied to steel plates. The PSA strip was pressed down twice onto the substrate using a 2 kg weight. The adhesive tape was then removed instantaneously from the substrate at 300 mm/min and at an angle of 180°. The steel plates were washed twice with acetone and once with isopropanol. The results are reported in N/cm and are averaged from three measurements. All measurements were carried out at room temperature under climate-controlled conditions.

Gel Permeation Chromatography GPC (Test C)

The average molecular weight M_{w} and the polydispersity PD were determined by gel permeation chromatography. The eluent used was THF containing 0.1% by volume trifluoroacetic acid. Measurement was carried out at 25° C. The precolumn used was PSS-SDV, 5μ, 10³ Å, ID 8.0 mm×50 mm. Separation was carried out using the columns PSS-SDV, 5μ, 10³ and also 10⁵ and 10⁶ each with an ID of 8.0 mm×300 mm. The sample concentration was 4 g/l, the flow rate 1.0 ml per minute. Measurement was carried out against PMMA standards.

Preparation of the Samples:

Preparation of the Monomers:

### (I) Preparation of 1-(4′-acetoxyphenyl)-1-(2″,2″,6″,6″-tetramethyl-1-piperidinyloxy)ethyl

The alkoxypiperidine compound was prepared as per the experimental instructions from Journal Polymer Science, Part A: Polymer Chemistry 1998, 36, 2161. The coupling of TEMPO with acetoxystyrene was carried out using a Jacobsen catalyst.

### (II) Preparation of 1-(4′-hydroxyphenyl)-1-(2″,2″,6″,6″-tetramethyl-1-piperidinyloxy)ethyl

The procedure adopted was similar to that of the experimental instructions in Macromolecules, 1998, 31, 1024-1031. The alkoxyamine from (I) was hydrolyzed with ammonium hydroxide at 65° C.

### (III) Preparation of the alkoxyamine A 1-(4′-acryloylethylcarbamoylphenyl)-1-(2″,2″,6″,6″-tetramethyl-1-piperidinyloxy)ethyl

The acrylation of the hydroxyl function was carried out with 2-isocyanatoethyl acrylate and alkoxyamine from (II), with formation of carbamate, by the method of Satchell and Satchell, Chemical Society Reviews 1975, 4, 231-250 and the references described therein.

### (IV) Preparation of the nitroxide (2,2,5-trimethyl-4-phenyl-3-azahexane 3-nitroxides)

The procedure adopted was similar to that of the experimental instructions in Journal of American Chemical Society, 121, 16, 3904-3920, 1999.

### (V) Preparation of 2,2,5-trimethyl-3-(4-acetoxy-1-phenylethoxy)-4-phenyl-3-azahexane

The procedure adopted was similar to that of the experimental instructions from Journal of American Chemical Society, 121, 16, 3904-3920, 1999. Styrene was substituted by 4-acetoxystyrene.

### (VI) Preparation of the hydroxylated alkoxyamine (2,2,5-trimethyl-3-(4-hydroxy-1-phenylethoxy)-4-phenyl-3-azahexane)

The procedure adopted was similar to that of the experimental instructions in Macromolecules, 1998, 31, 1024-1031. The compound from (V) was hydrolyzed with ammonium hydroxide at 65° C.

### (VII) Preparation of the acrylated nitroxide B (2,2,5-trimethyl-3-(4-acryloylethylcarbamoyl-1-phenylethoxy)-4-phenyl-3-azahexane)

The acrylation of the hydroxyl function was carried out with 2-isocyanatoethyl acrylate and alkoxyamine from (VI), with formation of carbamate, by the method of Satchell and Satchell, Chemical Society Reviews 1975, 4, 231-250 and the references described therein.

### EXAMPLE 1

A 2 l glass reactor conventional for free-radical polymerizations was charged with 32 g of acrylic acid, 346 g of 2-ethylhexyl acrylate, 20 g of methyl acrylate, 2 g of compound A and 300 g of acetone/isopropanol (97:3). Nitrogen gas was passed through the reactor for 45 minutes, and the reactor was degassed twice, and then heated with stirring to 58° C., and 0.2 g of azoisobutyronitrile (AIBN) was added. Subsequently the external heating bath was heated to 60° C. and the reaction was carried out constantly at this external temperature. After a reaction time of 1 h a further 0.2 g of AIBN was added. After 3 h and 6 h dilution was carried out with 150 g of acetone/isopropanol mixture each time. The reaction was terminated after a time of 22 h and the reaction mixture cooled to room temperature.

The average molecular weight M_{w} according to GPC measurements was 765 000 g/mol. For adhesion testing the adhesive was applied at a rate of 50 g/m² (based on solids) to a primed PET film (23 μm thick). The specimens were then cured with a 30 kGy EBC dose at an acceleration voltage of 230 kV. Adhesion testing then took place by test methods A and B.

### EXAMPLE 2

The procedure of example 1 was repeated. The polymerization was carried out using 16 g of acrylic acid, 20 g of methyl acrylate, 3 g of compound A and 361 g of 2-ethylhexyl acrylate. The further quantities of solvent and initiator were retained.

The average molecular weight M_{w} according to GPC measurements was 780 000 g/mol. Crosslinking took place with a 30 kGy dose.

Analysis was carried out using test methods A and B.

### EXAMPLE 3

The procedure of example 1 was repeated. The polymerization was carried out using 26 g of acrylic acid, 32 g of methyl acrylate, 8 g of compound A and 334 g of 2-ethylhexyl acrylate. The further quantities of solvent and initiator were retained.

The average molecular weight M_{w} according to GPC measurements was 812 000 g/mol.

Crosslinking took place with a 25 kGy dose.

Analysis was carried out using test methods A and B.

### EXAMPLE 4

The procedure of example 1 was repeated. The polymerization was carried out using 24 g of acrylic acid, 24 g of methyl acrylate, 0.6 g of compound A and 351.4 g of 2-ethylhexyl acrylate. The further quantities of solvent and initiator were retained.

The average molecular weight M_{w} according to GPC measurements was 775 000 g/mol.

Crosslinking took place with a 30 kGy dose.

Analysis was carried out using test methods A and B.

### EXAMPLE 5

The procedure of example 1 was repeated. The polymerization was carried out using 24 g of acrylic acid, 16 g of methyl acrylate, 8 g of compound B and 352 g of 2-ethylhexyl acrylate. The further quantities of solvent and initiator were retained.

The average molecular weight M_{w} according to GPC measurements was 770 000 g/mol.

Crosslinking took place with a 30 kGy dose.

Analysis was carried out using test methods A and B.

### EXAMPLE 6

The procedure of example 1 was repeated. The polymerization was carried out using 28 g of acrylic acid, 40 g of methyl acrylate, 4 g of compound B and 328 g of 2-ethylhexyl acrylate. The further quantities of solvent and initiator were retained.

The average molecular weight M_{w} according to GPC measurements was 815 000 g/mol.

Crosslinking took place with a 30 kGy dose.

Analysis was carried out using test methods A and B.

### EXAMPLE 1#

The procedure of example 1 was repeated. After a polymerization time of 22 h the acetone/isopropanol solvent was removed by distillation and the remaining reaction mixture was heated to 125° C. and admixed with 100 ml of xylene and 110 g of styrene. After 16 h the polymerization was cooled to room temperature.

The average molecular weight M_{w} according to GPC measurements was 965 000 g/mol. For adhesion testing the adhesive was applied at a rate of 50 g/m² (based on solids) to a primed PET film (23 μm thick) and dried at 135° C. for 10 minutes. The specimens were then cured with a 30 kGy EBC dose at an acceleration voltage of 230 kV. Adhesion testing then took place by test methods A and B.

### EXAMPLE 2#

The procedure of example 2 was repeated. After a polymerization time of 22 h the acetone/isopropanol solvent was removed by distillation and the remaining reaction mixture was heated to 125° C. and admixed with 100 ml of xylene and 82 g of styrene. After 16 h the polymerization was cooled to room temperature.

The average molecular weight M_{w} according to GPC measurements was 930 000 g/mol. For adhesion testing the adhesive was applied at a rate of 50 g/m² (based on solids) to a primed PET film (23 μm thick) and dried at 135° C. for 10 minutes. The specimens were then cured with a 30 kGy EBC dose at an acceleration voltage of 230 kV. Adhesion testing then took place by test methods A and B.

### EXAMPLE 3#

The procedure of example 3 was repeated. After a polymerization time of 22 h the acetone/isopropanol solvent was removed by distillation and the remaining reaction mixture was heated to 125° C. and admixed with 100 ml of xylene and 88 g of styrene. After 16 h the polymerization was cooled to room temperature.

The average molecular weight M_{w} according to GPC measurements was 980 000 g/mol. For adhesion testing the adhesive was applied at a rate of 50 g/m² (based on solids) to a primed PET film (23 μm thick) and dried at 135° C. for 10 minutes. The specimens were then cured with a 25 kGy EBC dose at an acceleration voltage of 230 kV. Adhesion testing then took place by test methods A and B.

### EXAMPLE 4#

The procedure of example 4 was repeated. After a polymerization time of 22 h the acetone/isopropanol solvent was removed by distillation and the remaining reaction mixture was heated to 125° C. and admixed with 100 ml of xylene and 50 g of styrene. After 16 h the polymerization was cooled to room temperature.

The average molecular weight M_{w} according to GPC measurements was 865 000 g/mol. For adhesion testing the adhesive was applied at a rate of 50 g/m² (based on solids) to a primed PET film (23 μm thick) and dried at 135° C. for 10 minutes. The specimens were then cured with a 30 kGy EBC dose at an acceleration voltage of 230 kV. Adhesion testing then took place by test methods A and B.

### EXAMPLE 5#

The procedure of example 5 was repeated. After a polymerization time of 22 h the acetone/isopropanol solvent was removed by distillation and the remaining reaction mixture was heated to 125° C. and admixed with 100 ml of xylene and 165 g of n-butyl acrylate. After 16 h the polymerization was cooled to room temperature.

The average molecular weight M_{w} according to GPC measurements was 1 020 000 g/mol.

For adhesion testing the adhesive was applied at a rate of 50 g/m² (based on solids) to a primed PET film (23 μm thick) and dried at 135° C. for 10 minutes. The specimens were then cured with a 30 kGy EBC dose at an acceleration voltage of 230 kV. Adhesion testing then took place by test methods A and B.

### EXAMPLE 6#

The procedure of example 6 was repeated. After a polymerization time of 22 h the acetone/isopropanol solvent was removed by distillation and the remaining reaction mixture was heated to 125° C. and admixed with 100 ml of xylene and 207 g of n-butyl acrylate. After 16 h the polymerization was cooled to room temperature.

The average molecular weight M_{w} according to GPC measurements was 1 170 000 g/mol.

For adhesion testing the adhesive was applied at a rate of 50 g/m² (based on solids) to a primed PET film (23 μm thick) and dried at 135° C. for 10 minutes. The specimens were then cured with a 30 kGy EBC dose at an acceleration voltage of 230 kV. Adhesion testing then took place by test methods A and B.

Implementation of the Hotmelt Process in a Recording Extruder:

The shearing and thermal loading of the acrylate hotmelts was carried out using the Rheomix 610p recording extruder from Haake. The drive unit available was the Rheocord RC 300p device. The instrument was controlled using the PolyLab System software. The extruder was charged in each case with 52 g of the acrylate PSA/monomer mixture (˜80% fill level). The experiments were carried out with a kneading temperature of 130° C., a rotary speed of 40 rpm and a kneading time of 18 hours. Thereafter the specimen was dissolved again and the average molecular weight M_{w} was determined via GPC.

### EXAMPLE 1*

In analogy to example 1, the acrylate PSA was freed from solvent after cooling, and 100 g of the acrylate hotmelt were mixed with 27.5 g of 4-acetoxystyrene. 52 g of this mixture were processed in the recording extruder as already described above. After the end of the reaction a molecular weight M_{w} of 975 000 g/mol was measured.

Adhesion testing was carried out using test methods A and B.

1. A method for producing copolymeric polyacrylate pressure-sensitive adhesives, in which a monomer mixture comprising acrylic acid and/or methacrylic acid and/or derivatives thereof is subjected to a free-radical polymerization, wherein, based on the monomer mixture, 0.05% to 25% by weight of acrylated or methacrylated nitroxide derivatives of the general formula
CH₂═C(R₁)(COOR₃) (II)
is used, where R₁═H or CH₃ and R₃ is a nitroxide derivative,
wherein a polyacrylate is reacted with a nitroxide derivative to give a nitroxide-modified polyacrylate corresponding to one obtained in accordance with the first alternative.

2. The method of claim 1, comprising free-radical polymerization of at least the following constituents:
(A) acrylic acid and/or methacrylic acid and/or derivatives thereof according to the formula
CH₂═C(R₁)(COOR₂) (I)
where R₁═H or CH₃ and R₂=an alkyl chain having 2-20 carbon atoms,
in a fraction of 45% to 99.95% by weight,
(B) acrylated or methacrylated nitroxide derivatives of the general formula
CH₂═CH(R₁)(COOR₃) (II)
where R₁═H or CH₃ and R₃ is a nitroxide derivative,
in a fraction of 0.05% to 25% by weight.

3. The method of claim 2, wherein the polymerization is additionally carried out with (C) at least one vinyl compound having functional groups, or a mixture thereof, in a fraction of 0% to 30% by weight, based on the monomer mixture.

4. The method of claim 1, wherein, as nitroxide derivative, a compound which is represented by one of the following general formulae is used:

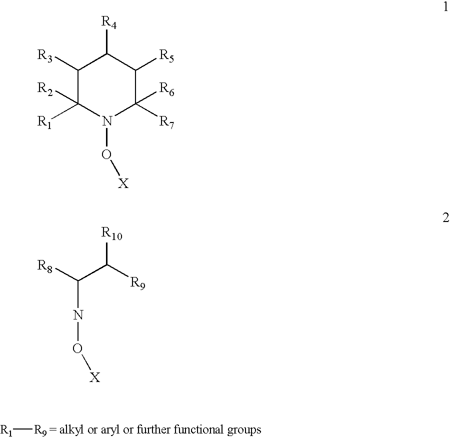

5. The method of claim 3, wherein the vinyl compound is selected from the group consisting of vinyl acetate, acrylamides, and photoinitiators functionalized with double bond.

6. The method of claim 1, wherein the polymerization takes place in solution.

7. The method of claim 1, wherein, in a further step, at least one further monomer is added to the nitroxide-modified polyacrylate and, after an increase in temperature to at least 100° C., a nitroxide-controlled free-radical polymerization, initiated by the cleavage of the nitroxide derivative and formation of free radicals along the polyacrylate backbone, is carried out to give a comb block polymer.

8. The method of claim 7, wherein the nitroxide-modified polyacrylate prepared in solution is admixed with the further monomer and thereafter is subjected to a concentration step at elevated temperature, thereby initiating the free-radical polymerization with the further monomer to give the comb block polymer.

9. The method of claim 7, wherein, following an optional concentration step, the nitroxide-modified polyacrylate is admixed with the further monomer and subsequently processed further in a hotmelt process, in which the free-radical polymerization with the further monomer is initiated to give the comb block polymer.

10. The method of claim 7, wherein the further monomer is styrene, a styrene derivative, an acrylate or a methacrylate.

11. The method of claim 10, wherein the molecular weight of the individual polystyrene blocks is adjusted to between 500 and 50 000 g/mol.

12. The method of claim 7, wherein the temperature of the polyacrylate composition for copolymerization with the further monomer is increased to 130° C.

13. A nitroxide-modified polyacrylate obtained by the method of claim 1.

14. The nitroxide-modified polyacrylate of claim 13, having an average molecular weight of between 500,000 and 2,000,000 g/mol (M_{w}).

15. A comb block polymer having pressure-sensitive adhesion properties, obtained by polymerizational attachment of blocks onto the nitroxide-modified polyacrylate of claim 13.

16. Pressure-sensitive adhesive articles comprising the comb block copolymer of claim 15.

17. A method for producing pressure-sensitive adhesive tapes or sheets which comprises coating one or both sides of a backing with a pressure-sensitive adhesive comprising or consisting of the comb block polymer of claim 15.

18. The pressure-sensitive adhesive articles of claim 16, wherein the comb block polymer, before or during processing to give the pressure-sensitive adhesive articles, has been blended with crosslinkers, resins, plasticizers, fillers or other additives or auxiliaries.

19. The method of claim 17, wherein the comb block polymer, before or during processing to give the pressure-sensitive adhesive articles, has been blended with crosslinkers, resins, plasticizers, fillers or other additives or auxiliaries.
